(19) United States
(12) Patent Application Publication
(10) Pub. No.: US 2019/0093865 A1
(43) Pub. Date: Mar. 28, 2019

(54) Portable Light Apparatus For Vehicle-Related Uses Including As Temporary Headlight Or Taillight

(71) Applicant: Forrest Walser, Prescott Valley, AZ (US)

(72) Inventor: Forrest Walser, Prescott Valley, AZ (US)

(21) Appl. No.: 15/717,411

(22) Filed: Sep. 27, 2017

(51) Int. Cl. F21V 21/096; F21L 4/08; F21V 23/04; F21V 21/08; F21S 8/10; F21S 9/02; F21V 14/06; F21V 21/40; F21V 17/10; F21V 17/02; B60Q 1/26; B60Q 1/30

(52) U.S. Cl. CPC F21V 21/0965; F21Y 2115/10; F21V 23/0414; F21V 21/0808; F21V 21/0832; F21S 48/1104; F21S 48/215; F21S 48/1131; F21V 23/0407; F21S 48/1233; F21S 48/2212; F21S 9/02; F21V 14/065; F21S 48/1721; F21V 21/406; F21V 17/107; F21V 17/02; B60Q 1/2615; B60Q 1/30; F21L 4/08

(57) ABSTRACT

A portable light apparatus for vehicle-related uses including as a temporary headlight or taillight is disclosed. The portable light includes an adjustable light beam, a swivel joint or hinge for aiming the light beam, and multiple attachment means to facilitate use on various types of vehicles and in a wide variety of situations. An exemplary embodiment of the herein disclosed portable light apparatus comprises a magnetic base for attaching to a vehicle, the magnetic base having one or more magnets and forming a strap slot of receiving a vehicle attachment strap; a light assembly having a light fixture, a battery, a switch, a lens cap, and a lens cap base; and, a hinged joint adjustably connecting the magnetic base to the light assembly and for aiming the portable light apparatus, the hinged joint having a tightening means for securing the hinged joint in place once aimed. The magnetic base may further include a latch for securing the light assembly to the magnetic base when in a closed position and an adhesive attachment for attaching to a vehicle.

### BRIEF DESCRIPTION OF THE INVENTION

The present invention relates to vehicle lights and vehicle lighting, and more particularly, to a portably and adjustable replacement light than may be utilized to temporarily replace either a headlight or a taillight of a vehicle as needed. The herein disclosed portable light apparatus includes an adjustable light beam, a swivel joint or hinge for aiming the light beam, and multiple attachment means to facilitate use on various types of vehicles and in a wide variety of situations.

An exemplary embodiment of the herein disclosed portable light apparatus comprises a magnetic base for attaching to a vehicle, the magnetic base having one or more magnets and forming a strap slot of receiving a vehicle attachment strap; a light assembly having a light fixture, a battery, a switch, a lens cap, and a lens cap base; and, a hinged joint adjustably connecting the magnetic base to the light assembly and for aiming the portable light apparatus, the hinged joint having a tightening means for securing the hinged joint in place once aimed. The magnetic base may further include a latch for securing the light assembly to the magnetic base when in a closed position, and an adhesive attachment for attaching to a vehicle.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

The present invention relates to the field of vehicle lights and vehicle lighting, and more particularly, to a portably and adjustable replacement light apparatus than may be utilized to temporarily replace either a headlight or a taillight of a vehicle as needed.

Most vehicles have two headlights spaced apart on either side of the front of the vehicle, two taillights spaced apart on either side of the back of the vehicle, and very often additional signaling lights, auxiliary lights, or decorative lights. Any of these lights may fail because of bulbs burning out, wiring deteriorating, or damage sustained in an accident. In any other these cases, the vehicle may be left with less than adequate exterior lighting. If it is a headlight or taillight that fails, the lack of one or more major exterior vehicle lights may pose a dangerous situation for the vehicle's occupants because the driver will have reduced outward visibility and, more importantly, the visibility of the vehicle to oncoming vehicles will also be reduced.

Often it is not possible for the driver or passengers to have failed vehicle lights repaired immediately. The driver may have to drive may miles, perhaps during the night, before finding a service station where the failed light may be repaired. It is clearly desirable to have a temporary replacement light that may be carried in a vehicle and utilized immediately upon the need arising.

Several temporary light devices have been developed to address the issue of failed vehicle lights. U.S. Pat. No. 5,685,631 to Dobert et al. discloses a safety light for magnetically securing to a vehicle to replace failed safety or auxiliary lights. US Published Patent Application No. U52014/0307455 to Owston discloses a temporary marker light for a truck that attaches by adhesive. U.S. Pat. No. 7,963,682 to McAnally discloses a temporary headlight reflector that attaches by adhesive.

But the devices disclosed in these references provide only limited options for attaching to a vehicle, and do not replace either a headlight or a taillight with a light beam-producing device. There is a need, therefore, for a temporary adjustable emergency headlight or taillight for a vehicle that provides a variety of attachment means so as to facilitate use with a wide variety of vehicles to replace a wide variety of external vehicle lights (including headlights or taillights).

### BRIEF DESCRIPTION OF THE SEVERAL VIEWS OF THE DRAWING

FIG. 1 illustrates a general overview of a portable light apparatus for temporarily replacing a headlight or a taillight of a vehicle, wherein the portable light apparatus is in a closed position and wherein the lens cap is illustrated separated so as to provide a view of the lens cap threading, in accordance with the present invention;

FIG. 2 illustrates a side view of a portable light apparatus for temporarily replacing a headlight or a taillight of a vehicle, wherein the portable light apparatus is in an open position to aim the light beam, in accordance with the present invention; and

FIG. 3 illustrates a top view of a portable light apparatus for temporarily replacing a headlight or a taillight of a vehicle, wherein the portable light apparatus is in a closed position, in accordance with the present invention.

### DETAILED DESCRIPTION OF THE INVENTION

The present invention relates to the field of vehicle lights and vehicle lighting, and more particularly, to a portably and adjustable replacement light apparatus than may be utilized to temporarily replace either a headlight or a taillight of a vehicle as needed. An exemplary embodiment of the herein disclosed portable light apparatus comprises a magnetic base for attaching to a vehicle, the magnetic base having one or more magnets and forming a strap slot of receiving a vehicle attachment strap; a light assembly having a light fixture, a battery, a switch, a lens cap, and a lens cap base; and, a hinged joint adjustably connecting the magnetic base to the light assembly and for aiming the portable light apparatus, the hinged joint having a tightening means for securing the hinged joint in place once aimed. The magnetic base may further include a latch for securing the light assembly to the magnetic base when in a closed position and an adhesive attachment for attaching to a vehicle.

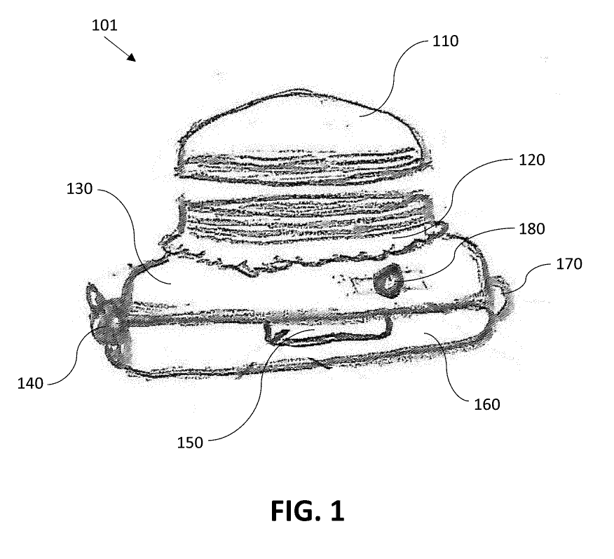

Referring to FIG. 1, portable light apparatus 101 is illustrated in a closed position. Portably light apparatus 101 includes a light assembly comprising lens cap 110, lens cap base 120, light fixture 130 (which may include a battery), and switch 180. The light assembly is adjustably attached to magnetic base 160 by hinge 140. Latch 170 may be provided to secure portably light apparatus 101 in a closed position when desired.

Lens cap 110 may be any lens known in the art capably of adjustably controlling a light beam emitted by light fixture 130. Lens cap 110 may include threading for interacting with threading included in lens cap base 120. In this way, lens cap 110 may be removable from the remaining components of the light assembly so as to provide access to clean, repair, or replace light fixture 130. Lens cap 110 may include a plurality of lens caps that may be switched-out (or selected) depending on whether a headlight of a taillight of the vehicle is to be replaced. For example, portable light apparatus 101 may include a headlight lens cap with a relatively clear lens color for use as a headlight replacement light and additionally include a taillight lens cap with a red lens color for use as a taillight replacement light. In this example, a user would select the particular lens cap most appropriate for the situation, and attach the particular lens cap onto lens cap base 120 via the threading formed by lens cap base 120. Those skilled in the art will recognize that additional lens colors (or lens characteristics) may be utilized at lens cap 110 for certain situations—for example, a blue color lens may be utilized in certain emergency or auxiliary situations—and all such lens colors or characteristics are intended to be included herein.

Lens cap base 120 may additionally include threading for interacting with threading included in lens cap 110. Lens cap base 120 may be rotatable to adjust the light beam emitted by light fixture 130, as is known in the art. Lens cap base 120 may form a protruding grip, as illustrated in the various Figures, to facilitate rotation of lens cap base 120. In an exemplary embodiment, and as illustrated in the various Figures, the protruding grip formed by lens cap base 120 may include a texture, such as a wavy or flower-like texture, so facilitate gripping and rotating by a user.

Light fixture 130 is located within the body of the light assembly of portably light apparatus 101. Light fixture 130 may be any type of light fixture known in the art. In a preferred embodiment of the present invention, light fixture 130 is a LED (light-emitting diode) utilizing low energy to provide a long-lasting and high output light beam. Light fixture 130 may be capable of outputting a variably color light beam.

Portable light apparatus 101 includes a battery connectively coupled to light fixture 130. In an exemplary embodiment of the present invention, the battery may be located within a body housing light fixture 130 (for this reason, the battery is not visible in the Figures). In alternative embodiments, the battery may be located on an external surface of a body housing light fixture 130. The battery may be a rechargeable battery, which may be recharged through a power cord running outward from the light assembly. Such a power cord may include an adaptor for plugging the power cord into a cigarette lighter port of a vehicle. The battery, along with the other components of portable light apparatus 101, may be water-resistant or water-proof.

The light assembly of portable light apparatus 101 further includes switch 180 for controlling operation of portable light apparatus 101. Switch 180 may be any switch known in the art capable of facilitating on and off operation of portable light apparatus 101. In a preferred embodiment of the present invention, switch 180 may be a four-way switch having a first setting, a second setting, a third setting, and a fourth setting. In this preferred embodiment, the first setting may be off (meaning the light fixture emits no light beam), the second setting may be low (meaning the light fixture emits a relatively low level light beam providing relatively less illumination), the third setting may be high (meaning the light fixture emits a relatively high level light beam providing relatively more illumination), and the fourth setting may be flashing (meaning the light fixture emits a flashing, pulsating, or intermittent light beam).

Portable light apparatus 101 includes magnetic base 160. Magnetic base 160 is a structure that may itself be a magnet (or be magnetic), or may include one or more magnets on either the outer-bottom surface of magnetic base 160 or within the structure of magnetic base 160. The one or more magnets may be coated with a relatively thin rubberized material to prevent scratches on the metallic surface of the vehicle, as is known in the art. Magnetic base 160 provides one possible means of attachment to a vehicle in that the one or more magnets of magnetic base 160 removably attach to the metallic surface of a vehicle.

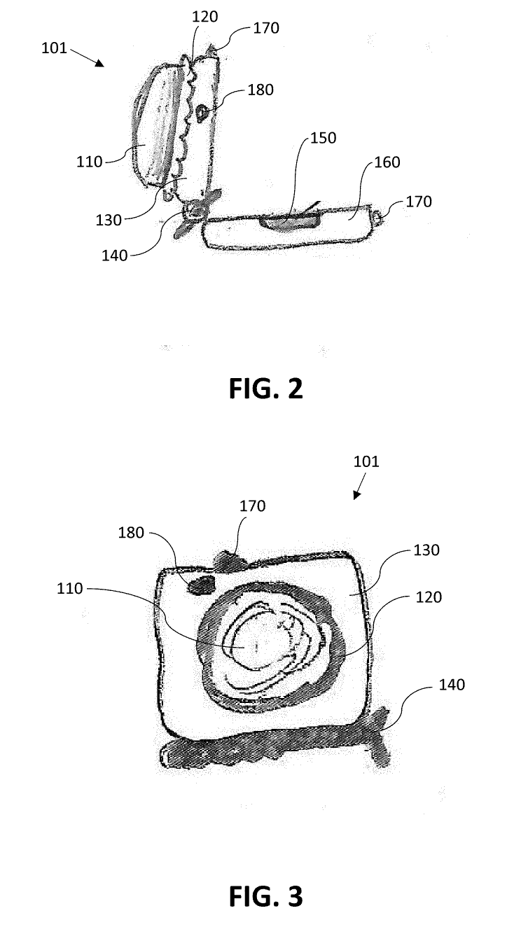

Magnetic base 160 forms strap slot 150, thereby providing an additional optional means for attachment to the vehicle. Strap slot 150 is a slot formed in the upper surface of magnetic base 160, as can be seen in FIG. 1 and FIG. 2. Strap slot 150 is a recessed slot providing a channel for an attachment strap to run through portable light apparatus 101. If a user wishes to attach portable light apparatus 101 to a vehicle using a strap, the strap may be run through strap slot 150 and then around a bumper of the vehicle, or example. The strap would then be tightened, applying the force of the strap to strap slot 150 and thus removably (or temporarily) attaching portable light apparatus 101 to the vehicle.

Magnetic base 160 may additionally include an adhesive attachment for providing an additional optional attachment means for attaching portable light apparatus 101 to a vehicle. A hook-and-loop system (also known as Velco) may be attached to a bottom surface of magnetic base 160, for example. Or alternatively, a sticky pad system may be attached to a bottom surface of magnetic base 160. Those skilled in the art will recognize that additional adhesive attachment systems for attaching magnetic base 160 to a vehicle are possible, and all such adhesive attachment systems are intended to be included herein.

Magnetic base 160 is adjustably connected to the light assembly of portable light apparatus 101 by hinge 140. Hinge 140 may be any type of hinge or other adjustable connection capable of adjustably connecting magnetic base 160 to the light assembly. The purpose of hinge 140 is to allow the light assembly to be tilted relative to magnetic base 160, so that magnetic base 160 may be attached to a vehicle at a convenient location, while allowing the light assembly to be adjusted thereafter to direct the light beam in an appropriate direction. Referring to FIG. 2, portably light apparatus 101 is illustrated in an open position. As can be seen, the light assembly has been tilted at approximately 90 degrees from magnetic base 160 at hinge 140, in order to direct the light beam in a desired direction. In a preferred embodiment, a wingnut may be utilized at hinge 140 for securing the light assembly in a desired position relative to magnetic base 160. Those skilled in the art will recognize that alternative means are possible for securing the light assembly in a desired position relative to magnetic base 160, and all such alternative means are intended to be included herein.

Portable light apparatus 101 may include latch 170 for securing the light assembly to magnetic base 160 when in a closed position. Any type of latch capable of holding the portable light apparatus 101 in a closed position may be utilized at latch 170.

Referring to FIG. 3, portable light apparatus 101 for temporarily replacing a headlight or a taillight of a vehicle is illustrated from a top view. The light assembly comprising lens cap 110, lens cap base 120 forming a textured protruding grip, light fixture 130 housed within a light fixture body (or structure), and switch 180 is adjustably attached to hinge 140 (which may include a wingnut in an ideal embodiment) and latch 170.

The present invention has been described as being attached to a vehicle to temporarily replace a headlight or taillight of the vehicle. But those skilled in the art will appreciate that the herein disclosed portable light apparatus may additionally be utilized as a temporary or portable emergency/indicator light (or use on the side of a road after an accident, for example), or alternatively, as a temporary or portable work light (to provide illumination of a car engine at night, for example), and all such related uses are intended to be included herein.

While the present invention has been illustrated and described herein in terms of a preferred embodiment and several alternatives, it is to be understood that the apparatus, devices and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A portable light apparatus for temporarily replacing a headlight or a taillight of a vehicle, comprising:
a magnetic base for attaching to a vehicle, the magnetic base having one or more magnets and forming a strap slot for receiving a vehicle attachment strap;
a light assembly having a light fixture, a battery, a switch, a lens cap, and a lens cap base; and
a hinged joint adjustably connecting the magnetic base to the light assembly and for aiming the portable light apparatus, the hinged joint having a tightening means for securing the hinged joint in place once aimed.

2. The portable light apparatus as recited in claim 1, wherein the magnetic base further includes an adhesive attachment for attaching to a vehicle.

3. The portable light apparatus as recited in claim 2, wherein the adhesive attachment is a hook and loop system.

4. The portable light apparatus as recited in claim 2, wherein the adhesive attachment is a sticky pad system.

5. The portable light apparatus as recited in claim 1, wherein the light fixture is an LED.

6. The portable light apparatus as recited in claim 1, wherein the light fixture is a variable color LED.

7. The portable light apparatus as recited in claim 1, wherein the battery is located within the light assembly and is rechargeable with power cord running outward from the light assembly to a vehicle cigarette lighter.

8. The portable light apparatus as recited in claim 1, wherein the switch is a four-way switch having a first setting, a second setting, a third setting, and a fourth setting.

9. The portable light apparatus as recited in claim 8, wherein the first setting is off, the second setting is low, the third setting is high, and the four setting is flashing.

10. The portable light apparatus as recited in claim 1, wherein the lens cap includes a headlight lens cap and a taillight lens cap, and wherein the headlight lens cap or the taillight lens cap may be selected depending on whether the headlight or the taillight is to be replaced.

11. The portable light apparatus as recited in claim 1, wherein the lens cap base is rotatable to adjust a light beam of the light fixture.

12. The portable light apparatus as recited in claim 11, wherein the lens cap base includes a textured protruding grip to facilitate rotation.

13. The portable light apparatus as recited in claim 1, wherein the tightening means is a wingnut.

14. The portable light apparatus as recited in claim 1, further including a latch for securing the light assembly to the magnetic base when in a closed position.
